(19) United States
(12) Patent Application Publication
(10) Pub. No.: US 2018/0278351 A1
(43) Pub. Date: Sep. 27, 2018

(54) CONTENT EVALUATING DEVICE, METHOD, AND STORAGE MEDIUM

(71) Applicant: KABUSHIKI KAISHA TOSHIBA, Tokyo (JP)

(72) Inventors: Kouta Nakata, Tokyo (JP); Yoshiaki Mizuoka, Kamakura Kanagawa (JP); Ryohei Orihara, Tokyo (JP)

(21) Appl. No.: 15/701,242

(22) Filed: Sep. 11, 2017

(30) Foreign Application Priority Data
Mar. 21, 2017 (JP) 2017-054824

(51) Int. Cl. H04H 60/31; H04N 21/442; H04N 21/466; G06F 11/34; H04H 60/66

(52) U.S. Cl. CPC H04H 60/31; H04N 21/44222; H04H 60/66; G06F 11/3476; H04N 21/4667

(57) ABSTRACT

According to one embodiment, a content evaluating device includes a first storage, a second storage and a processor. The first storage is configured to store a first viewing log indicating a device with which the first content has been viewed in the first region and a second viewing log indicating a device with which second content has been viewed in the first region. The second storage is configured to store evaluation information including an evaluation value that represents an evaluation of the second content in the second region. The processor is configured to calculate a predicted evaluation value of the first content in the second region in accordance with the first and second viewing logs and the evaluation value included in the evaluation information.

### CROSS-REFERENCE TO RELATED APPLICATIONS

This application is based upon and claims the benefit of priority from Japanese Patent Application No. 2017-054824, filed Mar. 21, 2017, the entire contents of which are incorporated herein by reference.

### FIELD

Embodiments described herein relate generally to a content evaluating device, a method, and a storage medium.

### BACKGROUND

There is a case where broadcast content that has been broadcast domestically is broadcast in a different region, for example, in overseas. In such a case, the content to be broadcast overseas is preferably the one selected from many kinds of content having been broadcast domestically which can obtain a high evaluation in overseas.

However, considering a difference in evaluation standards in overseas, it cannot guarantee whether the content receives a high evaluation an overseas even when the same content has been highly evaluated in the domestic market. Thus, it is difficult to predict the evaluation of the content in overseas that has been broadcast domestically.

### BRIEF DESCRIPTION OF THE DRAWINGS

FIG. 1 is a block diagram illustrating a configuration example of a content evaluating device according to a first embodiment;

FIG. 2 illustrates a data structure example of a viewing log stored in a viewing log storage;

FIG. 3 illustrates a data structure example of evaluation information stored in an evaluation information storage;

FIG. 4 is a flowchart illustrating a processing procedure example of the content evaluating device;

FIG. 5 is an explanatory view for specifically explaining predicted evaluation values;

FIG. 6 is a block diagram of a configuration example of a content evaluating device according to a second embodiment;

FIG. 7 illustrates a data structure example of attribute information stored in an attribute information storage;

FIG. 8 is a flowchart illustrating a processing example of generating an evaluation predicting model;

FIG. 9 illustrates a data structure example of feature information; and

FIG. 10 is a processing example of calculating a predicted evaluation value in overseas for prediction target content.

### DETAILED DESCRIPTION

In general, according to one embodiment, a content evaluating device for predicting an evaluation of first content in a second region which is different from a first region where the first content has been broadcast is provided. The content evaluating device includes a first storage, a second storage, and a hardware processor. The first storage is configured to store a first viewing log indicating a first device with which the first content has been viewed in the first region and a second viewing log indicating a second device with which second content that is different from the first content has been viewed in the first region. The second storage is configured to store evaluation information including an evaluation value that represents an evaluation of the second content in the second region, the second content having been broadcast in the second region. The hardware processor is configured to calculate a predicted evaluation value of the first content in the second region in accordance with the first viewing log, the second viewing log, and the evaluation value included in the evaluation information.

Various embodiments will be described hereinafter with reference to the accompanying drawings.

### First Embodiment

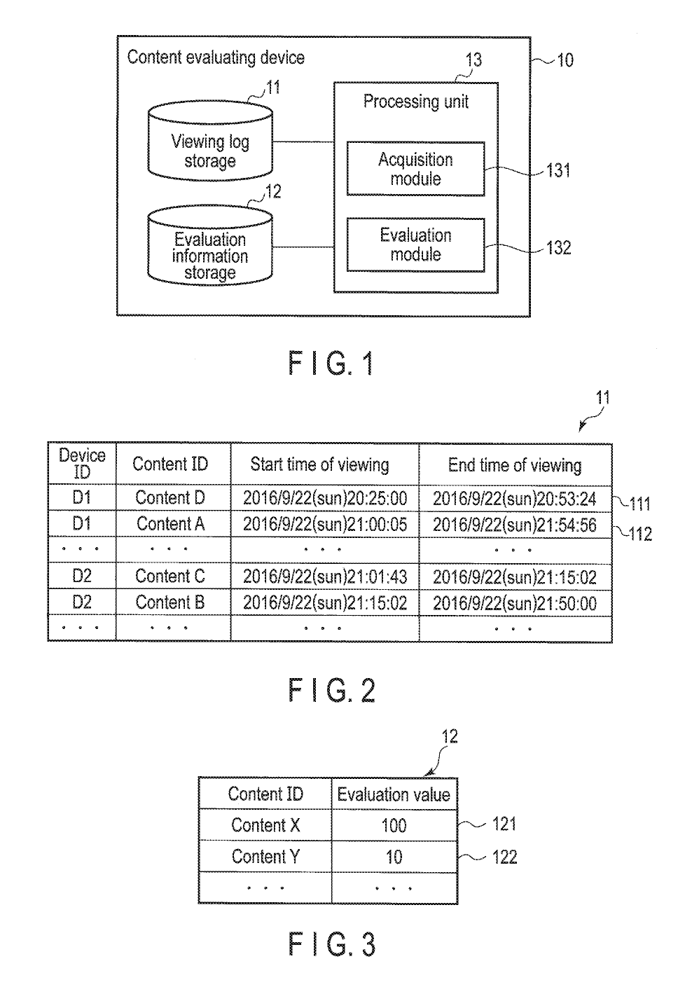

FIG. 1 is a block diagram illustrating a configuration example of a content evaluating device according to a first embodiment. A content evaluating device 10 of FIG. 1 includes a viewing log storage 11, an evaluation information storage 12, and a processing unit 13.

The viewing log storage 11 and the evaluation information storage 12 of the present embodiment are implemented by a storage device (memory), such as a hard disk drive (HDD) and a solid state drive (SSD) provided in the content evaluating device 10. The processing unit 13 is implemented by a computer provided in the content evaluating device 10 to execute a program stored in the storage device. The processing unit 12 includes a hardware processor and the like connected to the storage device.

The content evaluating device 10 of the present embodiment is used, for example, to predict an evaluation of content (e.g., a broadcast program or the like) in a second region different from a first region where the content has been broadcast. In the following description, it is assumed, for example, that the first region is a domestic region in the country and the second region is an overseas region.

The viewing log storage 11 stores a viewing log indicating that a viewer has viewed content, such as a TV program, with a video viewing device (hereinafter referred to as a viewing device) capable of viewing content. Assume that the viewing log storage 11 previously stores many viewing logs collected from a plurality of viewing devices capable of collecting the viewing logs. The viewing logs stored in the viewing log storage 11 include identification information (hereinafter referred to as a device ID) for identifying a viewing device with which the viewer has viewed the content. In the present embodiment, viewing of the content by the viewer means a case where the content is displayed on the viewing device. The data structure of the viewing logs will be described later.

Although the viewing log storage 11 of the present embodiment is included in the content evaluating device 10, the viewing log storage 11 may be provided in, for example, an external server device or the like of the content evaluating device 10.

There is a case where the content that has been broadcast domestically is provided to an overseas broadcast company for broadcast in overseas. The evaluation information storage 12, therefore, stores evaluation information including an evaluation value representing an overseas evaluation of the content that has been broadcast in overseas.

The processing unit 13 analyzes the viewing logs stored in the viewing log storage 11 and the evaluation information stored in the evaluation information storage 12 to execute prediction processing to predict the overseas evaluation of the content before the content that has been broadcast domestically is broadcast overseas.

The processing unit 13 includes an acquisition module 131 and an evaluation module 132. The acquisition module 131 acquires identification information (hereinafter referred to as a content ID) for identifying content (content scheduled to be broadcast in overseas) that has been broadcast domestically and hasn't been broadcast yet in overseas.

The evaluation module 132 calculates a predicted value of evaluation for the content. (hereinafter referred to as a predicted evaluation value of the content) in overseas identified by the content ID acquired by the acquisition module 131. The predicted evaluation value is calculated in accordance with the viewing log stored in the viewing log storage 11 and the evaluation value included in the evaluation information stored in the evaluation information storage 12.

FIG. 2 illustrates a data structure example of a viewing log stored in the viewing log storage 11 of FIG. 1. In the present embodiment, the viewing log represents a viewing history of a viewer who has viewed the content with a viewing device located domestically. That is, the viewing logs stored in the viewing log storage 11 of the present embodiment are the viewing logs collected domestically.

As illustrated in FIG. 2, the viewing logs stored in the viewing log storage 11 include the content ID, start time of viewing and end time of viewing in association with the device ID.

The device ID is identification information for identifying the viewing device with which the viewing log including the device ID has been collected.

The content ID is identification information for identifying the content that has been broadcast domestically and has been viewed with the viewing device identified by the device ID corresponding to the content ID.

The start time of viewing indicates day and time of starting viewing of the content identified by the content ID with the viewing device identified by the device ID corresponding to the start time of viewing.

The end time of viewing indicates day and time of ending viewing of the content identified by the content ID with the viewing device identified by the device ID corresponding to the end time of viewing.

The example of FIG. 2 illustrates a plurality of viewing logs including viewing logs 111 and 112 as the viewing logs collected from, for example, the viewing device identified by the device ID “D1”. The viewing logs collected from the viewing device identified by the device ID “D1” include the device ID “D1”.

Specifically, the viewing log ill includes the content ID “content D”, the start time of viewing “2016/9/22(sun)20:25:00”, and the end time of viewing “2016/9/22(sun)20:53:24” in association with the device ID “D1”. Thus, the viewing log 111 represents that, with the viewing device identified by the device ID “D1”, the content (program) identified by the content ID “content D” has been viewed from 20:25:00 of Sunday, Sep. 22, 2016 till 20:53:24 of Sep. 22, 2016.

The viewing log 112 includes the content ID “content A” the start time of viewing “2016/9/22(sun)21:00:05” and the end time of viewing “2016/9/22(sun)21:54:56” in association with the device ID “D1”. Thus, the viewing log 112 represents that, with the viewing device identified by the device ID “D1”, the content (program) identified by the content ID “content A” has been viewed from 21:00:05 on Sunday, Sep. 2, 2016 till 21:54:56 on. Sunday, Sep. 22, 2016.

Although not described in detail, the viewing log storage 11 stores all viewing logs collected from the viewing device identified by the device ID “D1” other than the viewing logs 111, 112 described above.

In the example of FIG. 2, the viewing log storage 11 also stores a plurality of viewing logs each including, for example, the device ID “D2” as the viewing logs collected from the viewing device identified by the device ID “D2”.

The viewing logs (or the data structure thereof) collected by the viewing device identified by the device ID “D2” are similar to the viewing logs (e.g., the viewing logs 111 and 11) collected from the viewing device identified by the device ID “D1”, and the detailed description thereof will be omitted.

Although FIG. 2 only illustrates the viewing logs collected from the viewing devices identified by the device IDs “D1” and “D2”, the viewing log storage 11 also stores other viewing logs collected from other viewing devices in a similar manner.

Each viewing log represents a viewing action for a piece of content in the present embodiment. The viewing action represented by each viewing log starts, for example, when the broadcasting of the content is started, the channel is changed, or the power of the viewing device is turned on. The viewing action ends when the broadcasting of the content is ended, the channel is changed, or the power of the viewing device is turned off.

FIG. 3 illustrates a data structure example of evaluation information stored in the evaluation information storage 12 of FIG. 1.

The evaluation information stored in the evaluation information storage 12 includes evaluation values each corresponding to a content ID, as illustrated in FIG. 3.

The content ID is the identification information allocated to the content for identifying, for example, the content that has been broadcast domestically.

The evaluation values are overseas evaluation values of the content when the content identified by the content ID corresponding to each evaluation value is broadcast in overseas after the content has been broadcast domestically.

Namely, the content ID included in the evaluation information is identification information for identifying the content that has been broadcast domestically and also broadcast in overseas. The evaluation values represent the evaluation of the content that has actually been evaluated in overseas.

The evaluation values are calculated (determined) from the viewing rating of the content, reviews of the content from overseas viewers or the like when the content has been broadcast in overseas.

In the example illustrated in FIG. 3, the evaluation information storage 12 stores a plurality of pieces of evaluation information including the evaluation information 121 and 122.

Namely, the evaluation information 121 includes the evaluation value “100” corresponding to the content ID “content X”. According to the evaluation information 121, an overseas evaluation value of the content identified by the content ID “content X” is 100.

In contrast, the evaluation information 122 includes an evaluation value “10” corresponding to the content ID “content Y”. According to the evaluation information 122, an overseas evaluation value of the content identified by the content ID “content Y” is 10.

Although not described in detail herein, the evaluation information storage 12 stores evaluation information including evaluation values representing the overseas evaluation of pieces of content that have been broadcast in overseas other than the evaluation information 121 and 122.

In the viewing logs and the evaluation information mentioned above, the same content ID is assigned to the same content (program).

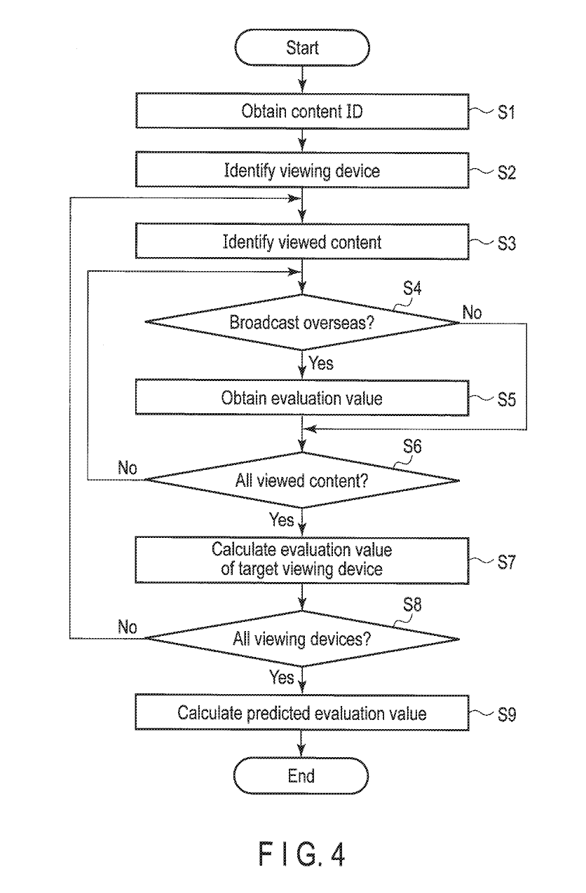

Next, a processing procedure of the content evaluating device 10 according to the present embodiment is described by referring to the flowchart of FIG. 4. The processing illustrated in FIG. 4 is executed by the processing unit 13 of the content evaluating device 10.

First, the acquisition module 131 of the processing unit 13 acquires a content ID for identifying content that has been broadcast domestically, but not yet been broadcast in overseas (step S1). The content identified by the content ID acquired in step S1 is, for example, the content for which overseas evaluation is predicted.

In step S1, the content ID to be acquired may be, for example, designated by an analyst or the like, or the content IDs for identifying pieces of content scheduled to be broadcast in overseas may he sequentially acquired.

In the following description, the content ID acquired in step S1 is referred to as a prediction target content ID, and the content identified by the prediction target content ID is referred to as prediction target content.

The evaluation module 132 of the processing unit 13 executes processing to calculate a predicted evaluation value of the prediction target content. The evaluation module 132 calculates the predicted evaluation value for the prediction target content according to an evaluation predicting model that uses the viewing log stored in the viewing log storage 11 and the evaluation information stored in the evaluation information storage 12. According to the evaluation predicting model of the present embodiment, if the prediction target content is viewed with the viewing device that has been used for viewing the content having a high overseas evaluation, a high predicted evaluation value is calculated as the predicted evaluation value for the prediction target content. In the following, the calculation of the predicted evaluation value is described in detail.

First, the evaluation module 132 of the processing unit 13 identifies the viewing device that has been used for viewing prediction target content (first content) in accordance with the viewing log (first viewing log) stored in the viewing log storage 11 (step S2). At this time, the evaluation module 132 is identifies the viewing device identified by the device ID included in the viewing log corresponding to the prediction target content ID.

The viewing log including the prediction target content ID indicates that the prediction target content has been viewed with the viewing device identified by the device ID included in the viewing log from the start time of viewing till the end time of viewing included in the viewing log.

If the prediction target content is regarded as having been viewed although the time between the start time of viewing and the end time of viewing is short, it would probably deteriorate prediction accuracy of evaluation of the content evaluating device 10.

In the present embodiment, it is determined whether the prediction target content has been viewed with the viewing device in accordance with the time between the start time of viewing and the end time of viewing (hereinafter referred to as viewing time). If the viewing time is equal to or more than a predetermined value, it is determined that the prediction target content has been viewed with the viewing device. Specifically, if the viewing time is at least 30 minutes, it can be determined that the prediction target content has been viewed wish the viewing device. It may be determined that the prediction target content has been viewed with the viewing device when the ratio of the viewing time relative to the total time between the start and end of the prediction target content is at least 0.5.

Namely, step S2 identifies the viewing device identified by the device ID included in the viewing log corresponding to the prediction target content ID, and with which the prediction target content has been viewed. A plurality of viewing devices may be identified in step S2.

The content of the present embodiment is not limited to the content including, for example, a program, and content constituted of, for example, a plurality of programs like a drama series (hereinafter referred to as series content) is also included. In the series content, the viewing of the series content is determined when it is determined that a predetermined number of programs of the plurality of programs constituting the series content has been viewed.

Next, the processing of steps S3 to S7 is executed for each viewing device identified in step S2. In the following description, the viewing device subjected to this processing is referred to as a target viewing device.

In this case, the evaluation module 132 identifies the content viewed with the target viewing device (hereinafter referred to as viewed content) in accordance with the viewing log (second viewing log) stored in the viewing log storage 11 (step S3). Specifically the evaluation module 132 identifies the content (second content) that is identified by the content ID included in the viewing log corresponding to the device ID used to identify the target viewing device and is also determined as having been viewed with the target viewing device similarly to step S2 as the viewed content. A plurality of pieces of viewed content may be identified in step S3.

Then, the processing of steps S4 and S5 is executed for each piece of the identified viewed content identified in step S3. In the following description, the viewed content subjected to the processing is referred to as target viewed content.

In this case, the evaluation module 132 determines whether the target viewed content has been broadcast overseas in accordance with the evaluation information stored in the evaluation information storage 12 (step S4). In step S4, it is determined that the target viewed content has been broadcast an overseas when the evaluation information including the content ID for identifying the target viewed content is stored in the evaluation information storage 12. Meanwhile, if the evaluation information including the content ID for identifying the target viewed content is not stored in the evaluation information storage 12, it is not determined that the target viewed content has been broadcast in overseas.

If no overseas broadcast has been determined in step S4 (NO at step S4), the processing of step S6, which will be described later, is executed.

In contrast, if the broadcast in overseas is determined in step S4 (YES at step S4), the evaluation module 132 acquires an evaluation value included in the evaluation information corresponding to the content ID used to identify the target viewed content (step S5).

When no broadcast in overseas is determined in step S4 and the processing of step S5 is executed, it is determined whether the processing of steps S4 and S5 is executed for all pieces of viewed content identified in step S3 (step S6).

If the execution of the processing on all pieces of viewed content is not determined. (NO at step S6), the process returns to step S4 to repeat the processing. Then, the processing of steps S4 and S5 is executed for the pieces of viewed content that have not been processed as the target viewed content.

Since the processing of steps S4 and S5 are executed on all pieces of viewed content, it is possible to acquire the evaluation value representing the overseas evaluation of the viewed content (hereinafter referred to as overseas evaluation values of the viewed content) that has been broadcast in overseas among the pieces of viewed content (i.e., the pieces of content having been viewed with the target viewing device).

If the execution of the processing on all pieces of viewed content is determined in step S6 (YES at step S6), the evaluation module 132 calculates the evaluation value of the target viewing device in accordance with the evaluation value acquired in step S5 (step S7). In this case, the evaluation module 132 calculates an average value of the evaluation values acquired in step S5 (i.e., the overseas evaluation values of each piece of the viewed content having been viewed with the target viewing device) as the evaluation value of the target viewing device.

The evaluation value of the target viewing device increases if the content having a high overseas evaluation is viewed with the target viewing device. In contrast, if the content having a low overseas evaluation is viewed with the target viewing device, the evaluation value of the target viewing device decreases.

When the processing of step S1 is executed, it is determined whether the processing of steps 53 to 57 has been executed on all viewing devices identified in step S2 (step S8).

I the processing of all viewing devices has not been executed (NO at step S8), the process returns to step S3 to repeat processing. Then, the processing of steps S3 to S7 is executed on the viewing devices to which the processing has not been executed as the target viewing devices.

By executing the processing of steps S3 to S7 on all viewing devices, the evaluation value of each viewing device with which the prediction target content has been viewed is calculated.

If it is determined in step S8 that the processing is executed on all viewing devices (YES at step S8), the evaluation module 132 calculates the predicted evaluation value of the prediction target content in accordance with the evaluation value of each viewing device calculated in step S7 (step SO). In this case, the evaluation module 132 calculates an average evaluation value of the viewing device as the predicted evaluation value of the prediction target content.

According to the processing illustrated in FIG. 4, a high predicted evaluation value is provided when the evaluation value of the viewing device with which the prediction target content has been viewed is high, while a low predicted evaluation value is provided when the evaluation value of the viewing device with which the prediction target content has been viewed is low.

By referring to FIG. 5, the predicted evaluation value calculated in the present embodiment is described in detail.

A table 151 illustrated on the upper side of FIG. 5 includes the content (i.e., content ID for identifying the content) having been broadcast in overseas, the overseas evaluation value for the content, and the viewing device (i.e., device ID for identifying the viewing device) with which the content has been viewed when the content has been broadcast domestically.

According to the table 151, the overseas evaluation value of the content identified bye the content ID “content X” (hereinafter simply referred to as the content X) is 100, and the viewing devices with which the content has been viewed when broadcast domestically are viewing devices identified by the device IDs “D1, D5, D6, D7” (hereinafter referred to as the viewing devices D1, D5, D6, D7).

Further, according to the table 151, the overseas evaluation value for the content identified by the content ID “content Y” (hereinafter simply referred to as the content Y) is 10, and the viewing devices with which the content has been viewed when broadcast domestically are viewing devices identified by the device IDs “D2, D3, D4” (hereinafter referred to as the viewing devices D2, D3, D4).

In the following description, it is assumed that the predicted evaluation value is calculated for the content identified by the content ID “content A” (hereinafter simply referred to as content A) which is the content that has been broadcast domestically, but not yet been broadcast in overseas.

As indicated in a table 152 illustrated on the lower side of FIG. 5, when the content A has been broadcast domestically, the content A has been viewed with the viewing devices D1, D2, D5, and D6.

According to the table 151, the content X that has been viewed with the viewing device D1 has an overseas evaluation value 100. If no other content which has been broadcast in overseas has been viewed with the viewing device D1 in addition to the content X, the evaluation value of the viewing device D1 is determined to 100. For simplification of explanation, it is assumed that only the content X has been viewed with the viewing device D1 among many pieces of content having been broadcast in overseas. If more than one piece of content which has been broadcast in overseas has been viewed with the viewing device D1, the average overseas evaluation value for the pieces of content is calculated as the evaluation value of the viewing device D1.

The evaluation values of other viewing devices D2, D5, and D6 with which the content A has been viewed are 10, 100, and 100, respectively, although not described in detail.

The predicted evaluation value of the content A is an average value of the evaluation values of the viewing devices D1, D2, D5, and D6 (i.e., the viewing devices with which the viewer has viewed the content A). Therefore, the predicted evaluation value for the content A is 77.5, according to the table 152, which is an average value of the evaluation values 100, 10, 100, and 100 of the viewing devices D1, D2, D5, and D6, respectively.

Next, the calculation of the predicted evaluation. value for content identified by the content ID “content B” (hereinafter simply referred to as content B) for the content that has been broadcast domestically, but not yet been broadcast in overseas is described.

As indicated in the table 152, when the content B has been broadcast domestically, the content B has been viewed with the viewing devices D3 and D4.

The table 151 indicates that the content Y that has been viewed with the viewing device 93 has the overseas evaluation value 10. If no other content which has been broadcast in overseas has been viewed with the viewing device 93 in addition to the content Y, the evaluation value of the viewing device 93 is 10.

The evaluation value of the viewing device D4 with which the content B has been viewed is 10, as in the viewing device 93.

The predicted evaluation value for the content B is an average value of the evaluation values of the viewing devices 93 and 94 (i.e., the viewing devices with which the viewer has viewed the content B). In this case, the predicted evaluation value for the content B is 10 which is an average value of the evaluation value 10 of the viewing device 93 and the evaluation value 10 of the viewing device D4, as illustrated in the table 152.

According to the predicted evaluation values of the content A and B, it can be predicted for example, that the content A is highly evaluated in overseas, while the content B is not highly evaluated in overseas.

As described above, the content evaluating device according to the present embodiment includes the viewing log storage 11 that stores the viewing logs (first and second viewing logs) including the device IDs for identifying the viewing devices used to view the content that has been broadcast domestically (first region), and the evaluation information storage 12 that stores the evaluation information including the evaluation values representing the overseas evaluation for the content (second content) that has been broadcast in overseas (second region), and calculates the predicted overseas evaluation value of the target prediction content (first content) in accordance with the viewing logs and the evaluation value (evaluation prediction model) included in the evaluation information.

Specifically, the content that has been viewed with the viewing device with which the prediction target content has been viewed is identified, the overseas evaluation value for the viewed content is acquired, and the predicted evaluation value is calculated in accordance with the acquired evaluation value.

Thus, according to such a configuration in the present embodiment, the high predicted evaluation value can be calculated when the prediction target content is viewed with the viewing device with which the content that is highly evaluated in overseas has been viewed. Namely, in the present embodiment, the predicted evaluation value is calculated on the basis of the prediction that the content that has been viewed by the viewer who has viewed the content having the high overseas evaluation would similarly have a high overseas evaluation. Unlike the case where only the domestic evaluation (viewing ratings or reviews) or the like is used to predict the overseas evaluation, the prediction is possible by considering the evaluation difference in different regions, thus improving the prediction accuracy.

The predicted evaluation value calculated in the present embodiment can be used as an objective index, for example, for promoting the content having been broadcast domestically to overseas.

Although the present embodiment has been mainly described by assuming that the first region is a domestic region and the second region is, for example, an overseas region, the first and second regions may be other regions a domestic region and an overseas region, so long as the first and second regions are different regions. Specifically, the first region may be a region in Kanto district in Japan, while the second region is located in another place in Japan where the content (program) is not broadcast, although the content is broadcast in Kanto district.

Namely, the present embodiment can be applied to a case where the evaluation of the content in the second region is predicted for the content that has been broadcast in the first region but not in the second region. This also can apply to the following embodiment.

### Second Embodiment

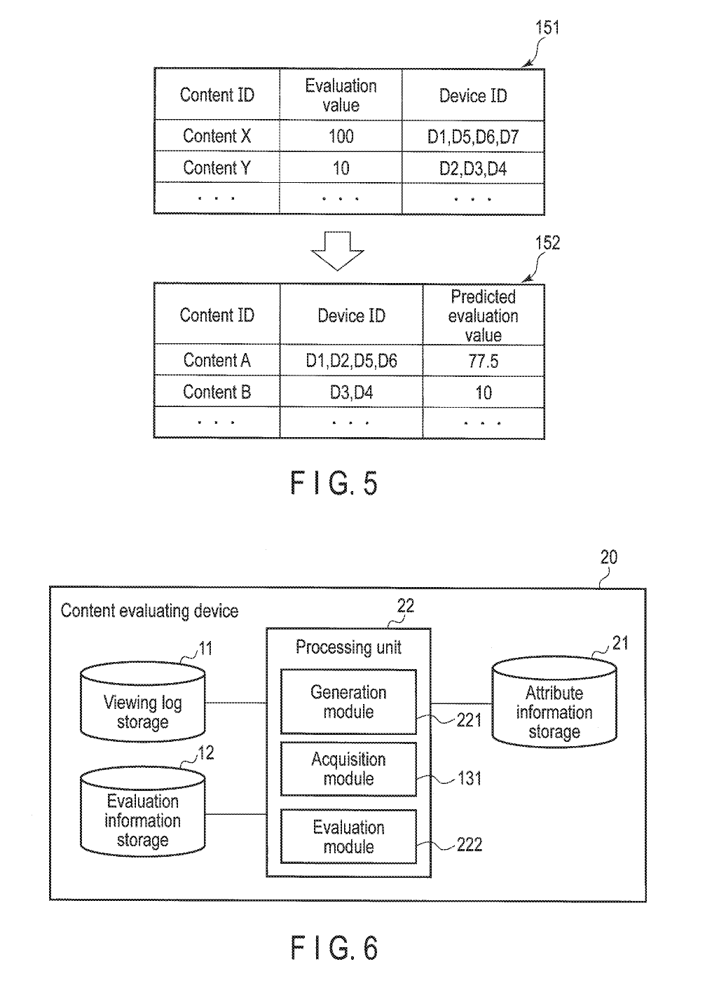

A second embodiment is described FIG. 6 is a block diagram of a configuration example of a content evaluating device according to the present embodiment. In FIG. 6, the same reference numerals are given to the same components similar to those in FIG. 1, and the description thereof will be omitted. A difference between FIGS. 1 and 6 is mainly explained herein.

The present embodiment differs from the first embodiment in that a predicted evaluation value is calculated in accordance with a relationship between a feature amount, which is based on attribute information (device information) regarding a viewing device (and a viewer viewing content with the viewing device), and an overseas evaluation value of the content.

A content evaluating device 20 of FIG. 6 includes an attribute information storage 21 and a processing unit 22. The attribute information storage 21 of the present embodiment is implemented by a storage device (memory), such as an HD or an SSD provided in the content evaluating device 20. The processing unit 22 is implemented by a computer provided in the content evaluating device 20 that executes a program stored in the storage device. The processing unit 12 includes a hardware processor and the like connected to the storage device.

The attribute information storage 21 previously stores information of viewing devices (hereinafter referred to as attribute information) for which viewing logs are collected. The attribute information includes, for example, demographic attributes of viewers who view the content with the viewing device and genre attributes of the content viewed with the viewing device.

The processing unit 22 analyzes the viewing logs stored in the viewing log storage 11, the evaluation information stored in the evaluation information storage 12, and attribute information stored in the attribute information storage 21, and executes predicting processing for predicting the overseas evaluation of the content before the content that has been broadcast domestically is broadcast in overseas.

The processing unit 22 includes a generation module 221 and an evaluation module 222. The generation module 221 generates an evaluation predicting model used to calculate the predicted evaluation value or the content (prediction target content) identified by the content ID acquired by the acquisition module 131. The generation module 221 calculates, for each piece of content, the feature amount of the viewing device in a set of viewing devices with which the content has been viewed in accordance with the attribute information stored in the attribute information storage 21. The generation module 221 generates an evaluation predicting model calculated for each content and the overseas evaluation value of the content.

The evaluation module 222 calculates the predicted evaluation value of the prediction target content using the evaluation predicting model generated by the generation module 221.

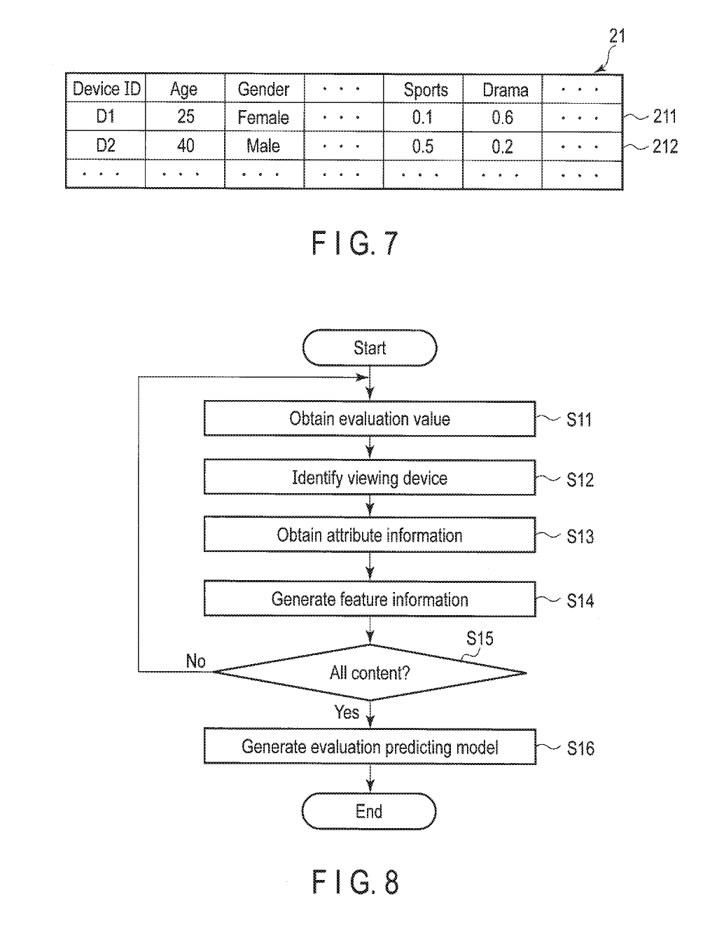

FIG. 7 illustrates a data structure example of the attribute information stored in the attribute information storage 21 of FIG. 6. The attribute information stored in the attribute information storage 21 includes, for example, demographic attributes and genre attributes associated with the device IDs.

The demographic attributes include attributes of the viewer who views the content with the viewing device identified by the device ID corresponding to the demographic attributes, such as age and gender. The demographic attributes may also include attributes (e.g., a region in which the viewer currently resides) other than the age and gender.

The genre attributes are attributes regarding the genre, such as sports and drama (genre) of the viewed content viewed with the viewing device identified by the device ID corresponding to the genre attribute. The genre attributes may include attributes (e.g., education and recreation) other than the sports and drama. In the attribute information, the genre attributes indicate a ratio of the content that belongs to the genre (attribute) among the pieces of content having been viewed with the viewing devices identified by the device IDs.

In the example of FIG. 7, the attribute information storage 21 stores a plurality of pieces of attribute information including attribute information 211 and 212.

Specifically, the attribute information 211 includes demographic attributes, such as age “25” and gender “female”, and genre attributes, such as sport “0.1” and drama “0.6” in association with the device ID “D1”. The demographic attributes included in the attribute information 211 indicate that the viewer who views content with the viewing device identified by the device ID “D1” is a female of age 25. The genre attributes included in the attribute information 211 indicate that a ratio of the content that belongs to the sports genre is 0.1 and a ratio of the content that belongs to the drama genre is 0.6 among pieces of content viewed with the viewing device identified by the device ID “D1”.

Meanwhile, the attribute information 212 includes demographic attributes, such as age “40” and gender “male”, and genre attributes, such as sport “0.5” and drama “0.2” in association with the device ID “D2”. The demographic attributes included in the attribute information 212 indicate that the viewer who views content with the viewing device identified by the device ID “D2” is a male of age 40. The genre attributes included in the attribute information 212 indicates that a ratio of the content that belongs to the sports genre is 0.5 and a ratio of the content that belongs to the drama genre is 0.2 among pieces of content viewed with the viewing device identified by the device ID “D2”.

Although not described in detail herein, the attribute information storage 21 stores attribute information, other than the attribute information 211 and 212, related to all viewing devices capable of collecting the viewing logs.

In the present embodiment, it is necessary to generate the evaluation predicting model mentioned above before the predicted evaluation value of the prediction target content is calculated.

Referring to the flowchart of FIG. 8, the generation of the evaluation predicting model is described. In the processing illustrated in FIG. 8, the following steps S11 to S14 are executed for pieces of content that have been broadcast both domestically and abroad. In the description regarding FIG. 8 below, the content subjected to this processing is referred to as target content.

The generation module 221 acquires an overseas evaluation value of the target content in accordance with the evaluation information stored in the evaluation information storage 12 (step S11). At this time, the generation module 221 acquires the evaluation value included in the evaluation information corresponding to the content ID used to identify the target content.

The generation module 221 identifies the viewing device with which the target content has been viewed domestically in accordance with the viewing log stored in the viewing log storage 11 (step S12 The viewing device to be identified in step S12 is the viewing device that is identified by the device ID included in the viewing log corresponding to the content ID used to identify the target content, and is determined as the viewing device with which the target content has been viewed. The processing to determine whether the target content has been viewed is described in the first embodiment, and the detailed description thereof will be omitted. A plurality of viewing devices may be identified in step S12.

The generation module 221 acquires the attribute information (second attribute information) of individual viewing devices identified in step S12 from the attribute information storage 21 (step S13). At this time, the generation module 221 acquires the attribute information including the device ID used to identify the viewing device identified in step S12.

The generation module 221 generates feature information representing a feature of a set of viewing devices (a set of viewing devices identified in step S12) with which the target content has been viewed, in accordance with the evaluation value acquired in step S11 and the attribute information acquired in step S13 (step S14).

Herein, assume that the attribute information of the data structure of FIG. 7 is acquired in step S13. In this case, the generation module 221 calculates the average age in the set of viewing devices mentioned above in accordance with the ages included in individual attribute information acquired in step S13. The generation module 221 also calculates the ratio of males and females in the set of the viewing devices in accordance with the gender included in the individual attribute information acquired in step S13. Further, the generation module 221 calculates an average ratio of sports (hereinafter referred to as a sports liking ratio) in the set of the viewing devices in accordance with the sports (the ratio of the content belonging to 2.5 the sports genre and viewed with the viewing devices) included in the individual attribute information acquired in step S13. Similarly, the generation module 221 calculates an average ratio of drama (hereinafter referred to as a drama liking ratio) in the set of the viewing devices in accordance with the drama (the ratio of the content belonging to the drama genre and viewed with the viewing devices) included in the individual attribute information acquired in step S13.

The average age, the male and female ratios, the calculated herein correspond to a feature amount of the set of viewing devices.

The generation module 221 generates the feature information including the evaluation values acquired in step S11 and the feature amount calculated above (i.e., the average age, the male and female ratios, and the sports and drama liking ratios in the set of viewing devices).

After the execution of the processing in step S14, it is determined whether the processing of steps S11 to S14 has been executed for all pieces of content that have been broadcast both domestically and abroad (step S15).

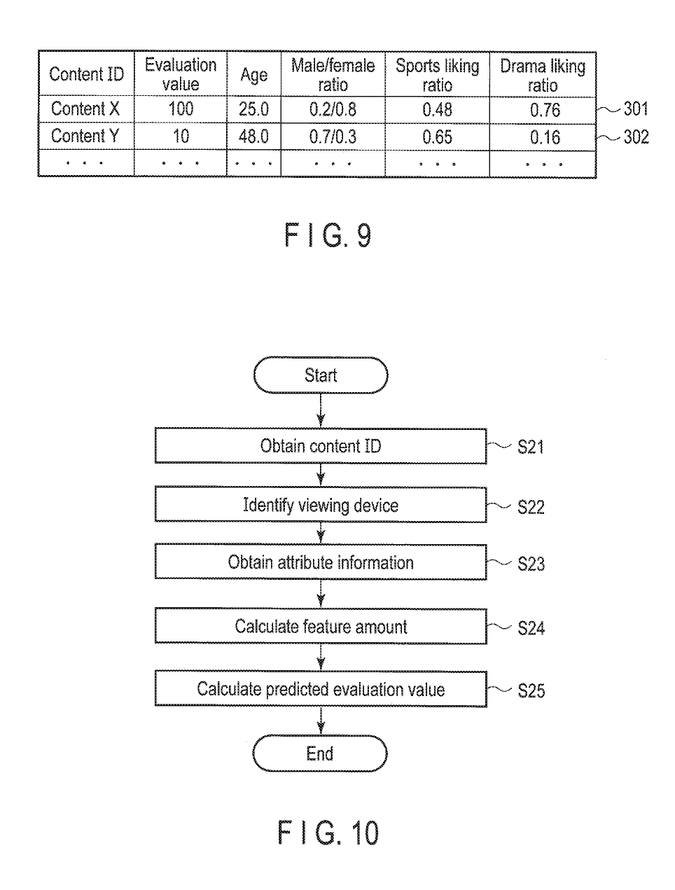

If it is determined that the processing has not been executed for all pieces of content (NO at step S15), the process returns to step S11 to repeat the processing. At this time, the processing of steps S11 to S14 is executed on the content to which the processing has not been executed as the target content. Thus, the feature information, which represents the feature of the set of viewing devices with which each of content has been viewed, is generated as illustrated in FIG. 9 by executing the processing of the steps S11 to S14 for all pieces of content.

FIG. 9 illustrates feature information 301 representing the feature of the set of viewing devices with which the content identified by the content ID “content X” (hereinafter referred to as content X) has been viewed, and feature information 302 representing the feature of the set of viewing devices with which the content identified by the content ID “content. Y” (hereinafter referred to as content Y) has been viewed.

For example, the feature information. 301 includes the evaluation value “100”, the age “25.0”, the male/female ratio “0.2/0.8”, the sports liking ratio “0.48”, and the drama liking ratio “0.76” in association with the content ID “content X”. The feature information 301 indicates that the overseas evaluation value for the content X is 100. Also, it is indicated that the average age is 25.0 for the set of viewing devices with which the content X has been viewed. In addition, it is indicated that the male ratio (the ratio of males among viewers) is 0.2 and the female ratio (the ratio of females among viewers) is 0.8 for the set of viewing devices with which the content X has been viewed. Further, it is indicated that the sports liking ratio (i.e., an average ratio of the content that belong to the sports genre among the pieces of content viewed with the set of viewing devices) in the set of viewing devices with which the content X has been viewed is 0.48, while the drama liking ratio (an average ratio of the content that belong to the drama genre among the pieces of content viewed with the set of viewing devices) is 0.76.

The feature information 302 includes the evaluation value “10”, the age “48.0”, the male/female ratio “0.7/0.3”, the sports liking ratio “0.65”, and the drama liking ratio “0.16” in association with the content ID “content Y”. According to the feature information 302, it is indicated the overseas evaluation value for the content Y is 10. Also, it is indicated is that the average age is 48.0 for the set of viewing devices with which the content Y has been viewed. In addition, it is indicated that the male ratio is 0.7 and the female ratio is 0.3 for the set of viewing devices with which the content Y has been viewed. Further, it is indicated that the sports liking ratio is 0.65 and the drama liking ratio is 0.16 in the set of viewing devices with which the content Y has been viewed.

Referring to FIG. 8 again, when it is determined that the processing has been executed on all pieces of content in step S15 (YES at step S15), the generation module 221 generates the evaluation predicting model in accordance with the feature information representing the feature of the set of viewing devices with which the individual pieces of content have been viewed, as illustrated in FIG. 9 (step S16).

In step S16, the generation module 221 generates an evaluation predicting model by, for example, a machine learning method called a decision tree or a support vector machine (SVM). This method can provide an evaluation predicting model that defines a relationship between the feature amount of the set of viewing devices with which the pieces of content have been viewed and the overseas evaluation values for the pieces of content.

The evaluation predicting model is updated as appropriate when the processing of FIG. 8 is regularly executed in response to the accumulation of the viewing logs in the viewing log storage 11, the accumulation of the evaluation information stored in the evaluation information storage 12, or update, addition or the like of the attribute information.

The present embodiment calculates the predicted overseas evaluation value, according to the evaluation predicting model generated in FIG. 8, for the content that has been broadcast domestically, but not in overseas (hereinafter referred to as the prediction target content).

Next, by referring to the flowchart of FIG. 10, processing of calculating the predicted overseas evaluation value for the target prediction content described.

First, the acquisition module 131 in the processing unit 13 acquires the content ID for identifying the prediction target content (step S21). The content ID acquired in step S21 may be designated by an analyst or the like, or the content IDs for identifying pieces of content to be broadcast overseas may be sequentially acquired.

Next, the evaluation module 222 of the processing unit 13 identifies the viewing device with which the prediction target content has been viewed domestically in accordance with the viewing logs stored in the viewing log storage 11 (step S22). The processing of step S22 is similar to the processing of step S12 illustrated in FIG. 8 described above.

The evaluation module 222 acquires the attribute information (first attribute information) related to the individual viewing devices identified in step S22 from the attribute information storage 21 (step S23). The processing of step S23 is similar to the processing of step S13 illustrated in FIG. 8 described above.

The evaluation module 222 also calculates the feature amount for the set of viewing devices (the set of viewing devices identified in step S22) with which the prediction target content has been viewed, in accordance with the attribute information acquired in step S23 (step S24).

At this time, the evaluation module 222 calculates, similarly to the processing of step S14 of FIG. 8, the average age, the male/female ratio, and the sports and drama liking ratios for the set of viewing devices with which the prediction target content has been viewed as the feature amount.

The evaluation module 222, then, calculates the predicted overseas evaluation value for the prediction target content by applying the feature amount calculated in step S24 to the evaluation predicting model, which has been generated by the generation module 221 in the processing of FIG. 8 (step S25). Accordingly, the value based on the overseas evaluation value for the content, which has been viewed by the set of viewing devices having the feature amount similar to the feature amount calculated in the step S24, is calculated as the predicted evaluation value.

As described above, in the present embodiment, the predicted evaluation value is calculated by applying the feature amount of the set of viewing devices with which the prediction target content has been viewed on the evaluation predicting model that defines the relationship between the feature amount of the set of viewing devices, with which the pieces of content have been viewed, and the overseas evaluation value for these pieces of content.

In the present embodiment, the predicted evaluation value can be calculated in accordance with the feature amount (or the trend thereof) of the set of viewing devices corresponding to the overseas evaluation value according to the evaluation predicting model. Thus, the prediction reflecting the evaluation difference in different regions can be carried out, and the prediction accuracy can he improved.

The present embodiment may use the domestic evaluation value for each piece of content in generating the evaluation predicting model. Specifically, assume that the content has a high evaluation value domestically, but its overseas evaluation value is low. If the feature amount of the set of viewing devices with which such content has been viewed is similar to the feature amount of the set of viewing devices with which the prediction target content has been viewed, the evaluation predicting model capable of outputting a negatively-weighted evaluation value may be generated.

The evaluation predicting model may be generated using other information (meta-information), such as the genre of the content or the cast of the program. Using such information, more detailed analysis can be carried out and the prediction accuracy can be improved.

According to at least one embodiment described above, a content evaluating device, a method, and a storage medium which are used for predicting the evaluation of content to be broadcast in different regions are provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content evaluating device for predicting an evaluation of first content in a second region which is different from a first region where the first content has been broadcast, the content evaluating device comprising:
a first storage configured to store a first viewing log indicating a first device with which the first content has been viewed in the first region and a second viewing log indicating a second device with which second content that is different from the first content has been viewed in the first region;
a second storage configured to store evaluation information comprising an evaluation value that represents an evaluation of the second content in the second region, the second content having been broadcast in the second region; and
a hardware processor configured to calculate a predicted evaluation value of the first content in the second region in accordance with the first viewing log, the second viewing log, and the evaluation value included in the evaluation information.

2. The content evaluating device of claim 1, wherein
the hardware processor is further configured to:
identify the second content that has been viewed with the first device used for viewing the first content in accordance with the first viewing log and the second viewing log,
acquire the evaluation value representing the evaluation of the identified second content in the second region from the second storage, and
calculate the predicted evaluation value in accordance with the acquired evaluation value.

3. The content evaluating device of claim 1, further comprising:
a third storage configured to store first attribute information related to the first device with which the first content has been viewed and second attribute information related to the second device with which the second content has been viewed,
wherein the hardware processor is further configured to calculate the predicted evaluation value by applying a feature amount of a set of devices with which the first content has been viewed based on the first attribute information to an evaluation predicting model that defines a relationship between a feature amount of the set of devices with which the second content has been viewed based on the second attribute information and an evaluation value included in the evaluation information.

4. A method executed by a content evaluating device for predicting an evaluation of first content in a second region which is different from the first region where the first content has been broadcast, the content evaluating method comprising:
acquiring a first viewing log indicating a first device with which the first content has been viewed and a second viewing log indicating a second device with which a second content that is different from the first content has been viewed;
acquiring evaluation information comprising an evaluation value that represents an evaluation of the second content in the second region, the second content having been broadcast in the second region; and
calculating a predicted evaluation value of the first content in the second region in accordance with the first viewing log, the second viewing log, and the evaluation value included in the evaluation information.

5. A non-transitory computer-readable storage medium having stored thereon a computer program which is executable by a computer of a content evaluating device for predicting an evaluation of first content in a second region which is different from a first region where the first content has been broadcast, the computer program comprising instructions capable of causing the computer to execute functions of:
acquiring a first viewing log indicating a first device with which the first content has been viewed and a second viewing log indicating a second device with which a second content which is different from the first content has been viewed;
acquiring evaluation information comprising an evaluation value that represents an evaluation of the second content in the second region, the second content having been broadcast in the second region; and
calculating a predicted evaluation value of the first content in the second region in accordance with the first viewing log, the second viewing log, and the evaluation value included in the evaluation information.
